(19) United States
(12) Patent Application Publication
(10) Pub. No.: US 2002/0033581 A1
(43) Pub. Date: Mar. 21, 2002

(54) Sealing profile, especially for a sliding roof seal

(76) Inventors: Dennis Rinse Nolles, Munchen (DE); Michael Kolbl, Neuried (DE); Thomas Schroferl, Hohenschaftlarn (DE)

Correspondence Address: NIXON PEABODY, LLP, 8180 GREENSBORO DRIVE, SUITE 800, MCLEAN, VA, 22102, US

(21) Appl. No.: 09/942,046

(22) Filed: Aug. 30, 2001

(30) Foreign Application Priority Data
Aug. 31, 2000 (DE) 100 43 154.2

(51) Int. Cl. F16J 3/00

(52) U.S. Cl. 277/628

(57) ABSTRACT

A sealing profile (1), especially for a sliding roof seal, with a deformation-stiff base area (2) which can be fixed on a component or a sliding roof cover (8), and an elastic sealing area (3) which arches over the base area (2) with the formation of a hollow chamber (12), the elastic seal area (3) having a coating (18) which contains an aliphatic polyurethane to improve the sliding properties of the elastic seal area (3). Furthermore another component of the coating (18) is a carbodiimide cross-linker, especially in a proportion of, for example, 5-8%. The coating (18) can contain N-methyl-2-pyrrolidone as another component.

### BACKGROUND OF THE INVENTION

1. Field of the Invention

The invention relates to a sealing profile, especially for a sliding roof seal, with a deformation-stiff base area which can be fixed on a component or a sliding roof cover, and an elastic sealing area which arches over the base area with the formation of a hollow chamber.

2. Description of Related Art

When a sliding roof cover is raised and/or moved, a seal which is attached to the peripheral edge of the cover and which with its elastic sealing area adjoins an opposite surface of a frame which surrounds the sliding roof opening, slides over this opposite surface. When the sealing area repeatedly briefly sticks to the opposite surface during the sliding motion, in the subsequent spontaneous transition from adhesive friction to sliding friction (stick-slip effect) disruptive creaking noise can arise.

German Patent DE 34 42 653 C1 discloses a hollow chamber seal as the seal of a gap between the sliding roof cover and the fixed roof area of a motor vehicle which surrounds the cover. The hollow chamber seal has a friction-reducing coating on its sealing area.

Published European Patent Application EP 0 615 874 A2 discloses a sliding roof cover of a motor vehicle which is sealed, by means of a seal which runs peripherally around the edge of the cover, against a frame which surrounds the roof opening. The seal is made of a inner, cover-side, vertically extending profile area of elastomer, for example, EPDM with a Shore A hardness of roughly 70. A hollow chamber profile of microcellular rubber is extruded onto this elastomer area on the outside, and the two parts can also be produced by co-extrusion. The outside surface of the hollow chamber profile contains polyester flocking for sealing against the frame of the roof opening.

In these known sealing profiles, silent operation at different temperatures and with a wet or dry environment is not ensured.

### SUMMARY OF THE INVENTION

A primary object of the present invention is to provide a sealing profile, which performs its sealing function without disruptive noise development when the component or the sliding roof cover is opened.

This object is achieved in a sealing profile of the initially mentioned type in that, in accordance with the invention, the elastic sealing area has a coating which contains an aliphatic polyurethane. Such a coating has friction-reducing properties so that the elastic sealing area can essentially no longer stick to the opposite surface or the adhesive force is so low that an almost continuous sliding motion of the elastic sealing area on the opposite surface is possible without disruptive creaking noise. The sealing profile is especially suitable for sealing the sliding roof cover of a motor vehicle, but can also be used to seal other components such as the covers of sliding and lifting roofs or spoiler roofs, raising covers or raising windows and similar movable parts.

As another component of the coating, there can be a carbodiimide cross-linker. This cross-linking agent can be contained especially in a proportion of, for example, 5-8%. Furthermore, the coating can contain, as another component, N-methyl-2-pyrrolidone to further improve the sliding properties. This coating has the best friction-reducing properties so that the elastic sealing area on the opposite surface can essentially no longer stick or the adhesive force is low such that almost continuous sliding motion of the elastic sealing area on the opposite surface is possible without disruptive creaking noise. Preferably, the coating contains fluorinated polyether (C₃F₆6O); this likewise reduces sticking of the seal and thus the coefficient of friction.

An embodiment is especially preferred in which the elastic sealing area is made of a EPDM microcellular rubber. The combination of the coating, for example, with a water-soluble 2-component PUR(N-methyl-2-pyrrolidone) slip enamel on which EPDM microcellular rubber offers clearly improved sliding behavior of the sealing area so that a stick-slip effect is prevented. However, other elastic materials, such as, for example, silicone, can also be used for the sealing area and likewise have better sliding behavior with the indicated coating. If the EPDM microcellular rubber is coated with a coarse grained polyurethane which can also contain fluorine particles the rough surface provides for a smaller contact area with the sealing opposite surface. By using microcelluar rubber, a lower total pressure force acting against the seal is sufficient for the sealing as the cells of the microcellular rubber exert pressure force by themselves.

Feasibly, the base area of the sealing profile is produced from a solid EPDM. Thus, the base area can be produced with the strength necessary for a carrier with increased deformation resistance. But, also other plastics can be used.

To attach the sealing profile to the component, it is a good idea if the base area of the sealing profile has a sealing foot for fixing the sealing profile to a holder on the periphery of a component or a sliding roof cover. The attachment can also take place for example by means of an adhesive connection over a planar outer side of the base area.

The holder for the sealing profile can be an edge injected onto the periphery of the sliding roof cover of plastic.

Preferably, the sealing area covers the top section of the base area on the top side. Thus, the sealing profile has a uniform appearance on the top which is visible in the installed state.

In the preferred embodiment, if the upper inner transition from the sealing area to the base area, avoiding material accumulation, is recessed in a wedge shape and runs especially to a point or with a small rounding radius, the deformation behavior of the sealing area is improved in the deformed seal engagement. Material accumulation in the transition area would lead to higher deformation resistance and this to a high pressure of the sealing area acting against the opposite surface, by which sticking and a stick-slip effect would be undesirably promoted. The configuration according to the invention avoids these defects.

One embodiment of the sealing profile is explained in detail below with reference to the accompanying drawings.

### BRIEF DESCRIPTION OF THE DRAWINGS

FIG. 1 is a cross-sectional view of a sealing profile on the edge of a sliding roof cover; and

FIG. 2 is a cross-sectional view in schematic form of the sealing profile in the deformed state in seal engagement on the opposite roof surface.

### DETAILED DESCRIPTION OF THE INVENTION

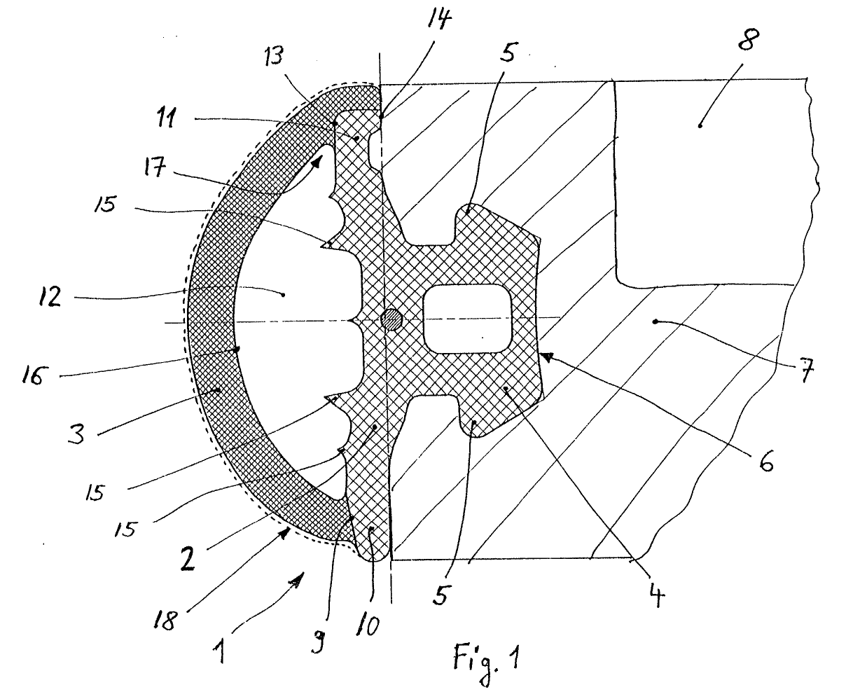

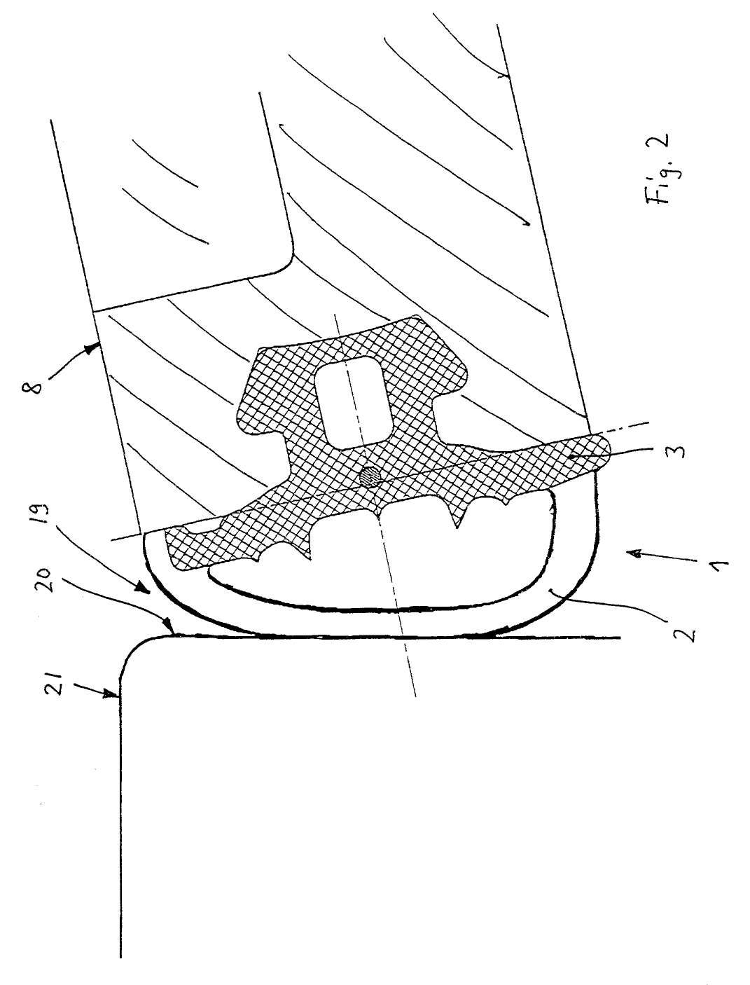

A seal for sealing the edge gap 19 between the sliding roof cover 8 of a motor vehicle and the opposite surface 20 on the frame 21 which surrounds the roof opening (see FIG. 2) contains a elongated sealing profile 1 with a base area 2 and a sealing area 3 (see FIG. 1). The base area 2 is formed as a hard molding, extruded, for example, from a solid EPDM (ethylene-propylene-diene-terpolymer) with a Shore A hardness of roughly 85, and provides an essentially deformation-free support structure for the sealing area 3. The base area 2 contains a sealing foot 4 with projections 5 which is securely held in the installation state of the sealing profile 1 in a corresponding groove-shaped and undercut recess 6 in a PU foam edge 7 which has been foamed onto the sliding roof glass cover 8.

The elastic sealing area 3 is, on the one hand, attached to the outer face side 9 in the lower section 10 of the base area 2, and on the other hand, on the top section 11 of the base area 2, and with formation of a hollow chamber 12, arches over the base area 2. The sealing area 3 is attached to the top section 11 of the base area 2 such that it adjoins both the face side 13 of the base area 2 and also completely covers the top section 11 on the top side, and in doing so, extends to the back-side contact edge 14 of the base area 2.

The base area 2 has several ribs 15 which project into the hollow chamber 12 and run especially to a point, and which are adjoined by the inner side 16 of the sealing area 3 simply in a line when the sealing area 3 is pressed completely against the base area 2. Thus, sticking of the inner side 16 of the sealing area 3 on the base area 2 is prevented.

On the top attachment of the sealing area 3 to the base area 2, an inner transition 17 is formed such that the hollow chamber 12 extends in a wedge shape into the transition, the imaginary tip of the wedge running to a point or having a rounded area with a small radius so that material accumulation is prevented in the transition 17. In this way, it is easier for the sealing area 3 to spring in, when the sealing profile 1 is in deformed seal engagement as, for example, for a cover 8 which has been raised about an axis at its front edge (see FIG. 2), and as a result of the reduced contact pressure, the tendency of the sealing area 3 to stick to the opposite sealing surface 20 is reduced.

The sealing area 3 is preferably produced from an EPDM microcellular rubber which has a density of roughly 0.7 g/cm³. The sealing area 3 is extruded, for example, onto the base area 2 or the sealing profile 1 is produced by co-extrusion of the base area 2 and of the sealing area 3.

To the outer side of the sealing area 3, a friction-reducing coating 18 (shown by a broken line) is attached which contains a 2-component polyurethane system. One component is an aliphatic polyurethane and the other component is a carbodiimide cross-linker which, for example, comprises a proportion of 5-8%. Another component can be N-methyl-2-pyrrolidone, for example, in a proportion of 1-3%. One such coating is known under the trade name Steel-Permutex. The coating which is present as a slip enamel and which is dried after spray application onto the sealing area 3, has an anti-stick effect, and when the glass cover 8 is raised, when the cover both on its front edge and also on its side edges and rear edge executes relative motion with respect to the frame 21, causes essentially continuous sliding of the sealing area 3 on the opposite surface 20 of the frame 21 without sticking so that creaking noise is prevented.

What is claimed is:

1. Sealing profile with a deformation-stiff base area which is fixable on a component and has an elastic sealing area which arches over the base area in a manner forming a hollow chamber therebetween, wherein the elastic seal area has a coating which contains an aliphatic polyurethane.

2. Sealing profile as claimed in claim 1, wherein another component of the coating is a carbodiimide cross-linker.

3. Sealing profile as claimed in claim 2, wherein the carbodiimide cross-linker comprises 5-8% of the coating.

4. Sealing profile as claimed in claim 2, wherein the coating also contains N-methyl-2-pyrrolidone.

5. Sealing profile as claimed in claim 1, wherein the coating also contains N-methyl-2-pyrrolidone.

6. Sealing profile as claimed in claim 1, wherein the coating contains fluorinated polyether (C₃F₆O).

7. Sealing profile as claimed in claim 4, wherein the elastic sealing area is made from an EPDM microcellular rubber.

8. Sealing profile as claimed in claim 1, wherein the elastic sealing area is made from an EPDM microcellular rubber.

9. Sealing profile as claimed in claim 8, wherein the base area of the sealing profile is made of solid EPDM.

10. Sealing profile as claimed in claim 1, wherein the base area of the sealing profile is made of solid EPDM.

11. Sealing profile as claimed in claim 1, wherein the component is a sliding roof cover, and wherein the base area of the sealing profile has a sealing foot for fixing the sealing profile to a holder on the periphery of the sliding roof cover.

12. Sealing profile as claimed in claim 11, wherein the sealing area covers a top section of the base area on a top side thereof.

13. Sealing profile as claimed in claim 1, wherein the sealing area covers a top section of the base area on a top side thereof.

14. Sealing profile as claimed in claim 1, wherein an upper inner transition from the sealing area to the base area is recessed in a wedge shape.

15. Sealing profile as claimed in claim 14, wherein the wedge shape runs to one of a point and a small rounding radius.

16. A sliding roof cover having a sealing profile with a deformation-stiff base area fixed on a peripheral edge thereof, said sealing profile having an elastic sealing area which arches over the base area in a manner forming a hollow chamber therebetween, wherein the elastic seal area has a coating which contains an aliphatic polyurethane.

17. A sliding roof cover as claimed in claim 16, wherein another component of the coating on the sealing profile is a carbodiimide cross-linker.

18. A sliding roof cover as claimed in claim 17, wherein the carbodiimide cross-linker comprises 5-8% of the coating.

19. A sliding roof cover as claimed in claim 17, wherein the coating also contains N-methyl-2-pyrrolidone.

20. A sliding roof cover as claimed in claim 16, wherein the coating also contains N-methyl-2-pyrrolidone.

21. A sliding roof cover as claimed in claim 16, wherein the sealing profile is attached to plastic holder formed onto the periphery of the sliding roof cover.
